(19) United States
(12) Patent Application Publication
(10) Pub. No.: US 2021/0302991 A1
(43) Pub. Date: Sep. 30, 2021

(54) METHOD AND SYSTEM FOR GENERATING AN ENHANCED FIELD OF VIEW FOR AN AUTONOMOUS GROUND VEHICLE

(71) Applicant: Wipro Limited, Bangalore (IN)

(72) Inventors: Balaji Sunil KUMAR, Bengaluru (IN); Manas SARKAR, Kolkata (IN)

(21) Appl. No.: 16/937,767

(22) Filed: Jul. 24, 2020

(30) Foreign Application Priority Data
Mar. 31, 2020 (IN) 202041014474

(51) Int. Cl. G05D 1/02

(52) U.S. Cl. CPC G05D 1/0248; G05D 1/0219; G05D 1/0251; G05D 1/0268

(57) ABSTRACT

This disclosure relates to method and system of generating an enhanced field of view (FoV) for an Autonomous Ground Vehicle (AGV). The method includes determining a set of regions of interest at a current location of an AGV, along a global path of the AGV. Further, for each of the regions of interest, the method includes receiving, for a region of interest, visual data from one or more sensor clusters located externally with respect to the AGV and at different positions. Further, for each of the regions of interest, the method includes for each of the one or more sensor clusters, generating, for a sensor cluster, perception data for the region of interest by correlating the visual data from the two or more vision sensors in the sensor cluster, and combining the one or more entities within the region of interest based on the perception data from the one or more sensor clusters to generate the enhanced FoV.

### TECHNICAL FIELD

This disclosure relates generally to Autonomous Ground Vehicles (AGVs), and more particularly to method and system for generating an enhanced field of view (FoV) for an AGV.

### BACKGROUND

Autonomous Ground Vehicles (AGVs) are increasingly deployed in a variety of indoor and outdoor settings so as to facilitate efficient transportation. The AGVs are capable of sensing changing environment, and of accurately navigating with little or no human intervention. In order to enable autonomous navigation, an AGV is equipped with multiple sensors and control arrangements. The AGV determines velocity and trajectory based on input data received from various sensors (for example, position sensors, orientation sensors, visual sensors, etc.).

However, there may be situations when a field of view (FoV) of visual sensors may be limited. For example, in a busy road flooded by vehicles, the FoV of the AGV may be obstructed due to presence of other vehicles on the road (for example, another vehicle ahead of the AGV, another vehicle beside the AGV in a side lane, etc.). In particular, the visual sensors connected to the AGV (for example, a LIDAR, a camera, etc.) may not receive environmental data properly, thereby limiting perception of the surrounding environment (for example, road regions, road-side environment, etc.). In such situations, the AGV may fail to determine the current velocity and the trajectory. Such situations may lead to fatal road accidents. Further, waiting for a clear view of the environment may make the AGV too late to respond in a critical job like localization, perception, motion planning, and the like.

In short, existing techniques fall short in providing an effective mechanism for generating the FoV for the AGV for local path planning and for localization. Further, existing techniques fail to provide a mechanism for supplementing the existing FoV of the AGV. Therefore, there is a need to enhance the FoV for the AGV.

### SUMMARY

In one embodiment, a method of generating an enhanced field of view (FoV) for an Autonomous Ground Vehicle (AGV) is disclosed. In one example, the method may include determining, by an enhanced FoV generation device, a set of regions of interest at a current location of an AGV, along a global path of the AGV. Further, for each of the set of regions of interest, the method may include receiving, for a region of interest by the enhanced FoV generation device, visual data from one or more sensor clusters located externally with respect to the AGV and at different positions. Each of the one or more sensor clusters includes two or more vision sensors at co-located frame position. Further, for each of the set of regions of interest, the method may include for each of the one or more sensor clusters, generating, for a sensor cluster by the enhanced FoV generation device, perception data for the region of interest by correlating the visual data from the two or more vision sensors in the sensor cluster, wherein the perception data corresponds to one or more entities within the region of interest. Further, for each of the set of regions of interest, the method may include combining, by the enhanced FoV generation device, the one or more entities within the region of interest based on the perception data from the one or more sensor clusters to generate the enhanced FoV.

In one embodiment, a system for generating an enhanced FoV for an AGV is disclosed. In one example, the system may include a processor and a computer-readable medium communicatively coupled to the processor. The computer-readable medium may store processor-executable instructions, which, on execution, may cause the processor to determine a set of regions of interest at a current location of an AGV, along a global path of the AGV. For each of the set of regions of interest, the processor-executable instructions, on execution, may further cause the processor to receive, for a region of interest, visual data from one or more sensor clusters located externally with respect to the AGV and at different positions. Each of the one or more sensor clusters includes two or more vision sensors at co-located frame position. For each of the set of regions of interest, the processor-executable instructions, on execution, may further cause the processor to for each of the one or more sensor clusters, generate, for a sensor cluster, perception data for the region of interest by correlating the visual data from the two or more vision sensors in the sensor cluster. The perception data corresponds to one or more entities within the region of interest. For each of the set of regions of interest, the processor-executable instructions, on execution, may further cause the processor to combine the one or more entities within the region of interest based on the perception data from the one or more sensor clusters to generate the enhanced FoV.

In one embodiment, a non-transitory computer-readable medium storing computer-executable instructions for generating an enhanced FoV for an AGV is disclosed. In one example, the stored instructions, when executed by a processor, may cause the processor to perform operations including determining a set of regions of interest at a current location of an AGV, along a global path of the AGV. For each of the set of regions of interest, the operations may further include receiving, for a region of interest, visual data from one or more sensor clusters located externally with respect to the AGV and at different positions. Each of the one or more sensor clusters includes two or more vision sensors at co-located frame position. For each of the set of regions of interest, the operations may further include for each of the one or more sensor clusters, generating, for a sensor cluster, perception data for the region of interest by correlating the visual data from the two or more vision sensors in the sensor cluster. The perception data corresponds to one or more entities within the region of interest. For each of the set of regions of interest, the operations may further include combining the one or more entities within the region of interest based on the perception data from the one or more sensor clusters to generate the enhanced FoV.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for generating an enhanced field of view (FoV) for an Autonomous Ground Vehicle (AGV), in accordance with some embodiments of the present disclosure.

FIG. 2 is a functional block diagram of an enhanced FoV generation device implemented by the exemplary system of FIG. 1, in accordance with some embodiments of the present disclosure.

FIG. 3 illustrates a flow diagram of an exemplary process for generating an enhanced FoV for an AGV, in accordance with some embodiments of the present disclosure.

FIG. 4 is a flow diagram of a detailed exemplary process for generating an enhanced FoV for an AGV, in accordance with some embodiments of the present disclosure.

FIGS. 5A and 5B illustrate identification of one or more entities corresponding to each of a set of regions of interest in on-road visual data, in accordance with some embodiments of the present disclosure.

FIGS. 6A and 6B illustrate identification of one or more entities corresponding to each of a set of regions of interest in road-side visual data, in accordance with some embodiments of the present disclosure.

FIG. 7 illustrates generation of a local path by combining on-road visual data received from two or more vision sensors corresponding to each of one or more sensor clusters, in accordance with some embodiments of the present disclosure.

FIG. 8 illustrates localization of the AGV by combining the road-side visual data received from two or more vision sensors corresponding to each of one or more sensor clusters, in accordance with some embodiments of the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

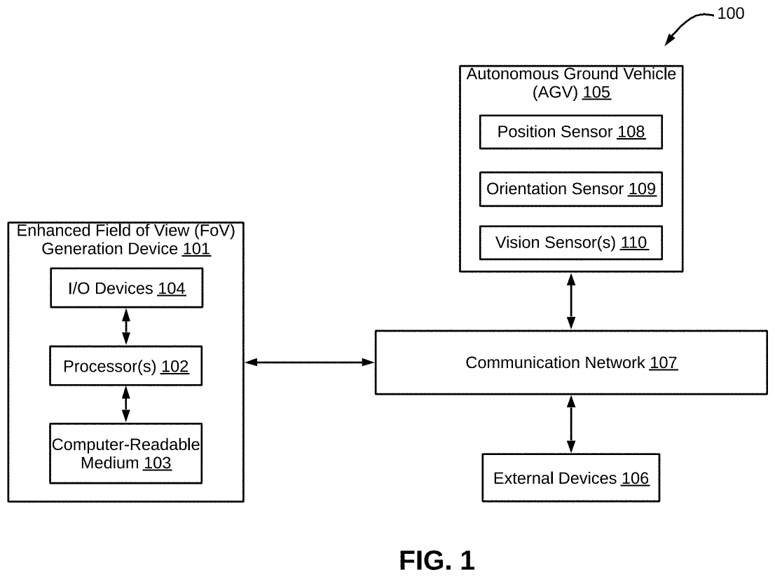

Referring now to FIG. 1, an exemplary system 100 for generating an enhanced field of view (FoV) for an Autonomous Ground Vehicle (AGV) 105 is illustrated, in accordance with some embodiments of the present disclosure. In particular, the system 100 may include an enhanced FoV generation device 101 that may generate the enhanced FoV for the AGV 105, in accordance with some embodiments of the present disclosure. The enhanced FoV generation device 101 may generate the enhanced FoV for the AGV 105 using visual data from one or more sensor clusters located externally with respect to the AGV 105 and at different positions. It should be noted that, in some embodiments, the enhanced FoV generation device 101 may determine a set of regions of interest along a global path of the AGV 105 to generate the enhanced FoV. The enhanced FoV generation device 101 may take the form of any computing device including, but not limited to, a server, a desktop, a laptop, a notebook, a netbook, a tablet, a smartphone, and a mobile phone.

Further, as will be appreciated by those skilled in the art, the AGV 105 may be any vehicle capable of sensing the dynamic changing environment, and of navigating without any human intervention. Thus, the AGV 105 may include one or more sensors, a vehicle drivetrain, and a processor-based control system, among other components. The one or more sensors may sense dynamically changing environment by capturing various sensor parameters. The sensors may include a position sensor 108, an orientation sensor 109, and one or more vision sensors 110. In some embodiments, the position sensor 108 may acquire an instant position (i.e., current location) of the AGV 105 with respect to a navigation map (i.e., within a global reference frame). The orientation sensor 109 may acquire an instant orientation (i.e., current orientation) of the AGV 105 with respect to the navigation map. The one or more vision sensors 110 may acquire an instant three-dimensional (3D) image of an environment around the AGV 105. In some embodiments, the 3D image may be a 360 degree FoV of the environment (i.e. environmental FoV) that may provide information about presence of any objects in the vicinity of the AGV 105. Further, in some embodiments, the 3D image may be a frontal FoV of a navigation path (i.e., navigational FoV) of the AGV 105. By way of an example, the position sensor 108 may be a global positioning system (GPS) sensor, the orientation sensor 109 may be an inertial measurement unit (IMU) sensor, and the vision sensor 110 may be selected from a Light Detection And Ranging (LiDAR) scanner, a camera, a LASER scanner, a Radio Detection And Ranging (RADAR) scanner, a short-range RADAR scanner, a stereoscopic depth camera, or an ultrasonic scanner.

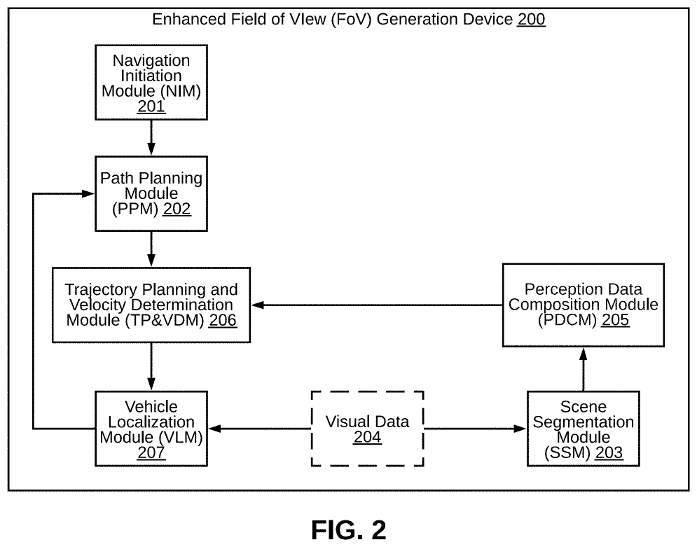

As will be described in greater detail in conjunction with FIGS. 2-8, the enhanced FoV generation device 101 may determine a set of regions of interest at a current location of an AGV, along a global path of the AGV. For each of the set of regions of interest, the enhanced FoV generation device 101 may further receive, for a region of interest, visual data from one or more sensor clusters located externally with respect to the AGV and at different positions. Each of the one or more sensor clusters includes two or more vision sensors at co-located frame position. For each of the set of regions of interest, the enhanced FoV generation device 101 may further, for each of the one or more sensor clusters, generate, for a sensor cluster, perception data for the region of interest by correlating the visual data from the two or more vision sensors in the sensor cluster. It may be noted that the perception data corresponds to one or more entities within the region of interest. For each of the set of regions of interest, the enhanced FoV generation device 101 may further combine the one or more entities within the region of interest based on the perception data from the one or more sensor clusters. In some embodiments, the enhanced FoV generation device 101 may further generate the enhanced FoV based on the perception data and the combined one or more entities for each of the set of regions of interest.

In some embodiments, the enhanced FoV generation device 101 may include one or more processors 102 and a computer-readable medium 103 (for example, a memory). The computer-readable storage medium 103 may store instructions that, when executed by the one or more processors 102, cause the one or more processors 102 to identify the one or more entities corresponding to each of the perception data for the region of interest and generate the enhanced FoV for the AGV 105, in accordance with aspects of the present disclosure. The computer-readable storage medium 103 may also store various data (for example, on-road visual data and road-side visual data from at least one of proximal vehicles and proximal infrastructures, global path of the AGV 105, local path plan of the AGV 105, the set of regions of interest, and the like) that may be captured, processed, and/or required by the system 100.

The system 100 may further include I/O devices 104. The I/O devices 104 may allow a user to exchange data with the enhanced FoV generation device 101 and the AGV 105. The system 100 may interact with the user via a user interface (UI) accessible via the I/O devices 104. The system 100 may also include one or more external devices 106. In some embodiments, the enhanced field of view (FoV) generation device 101 may interact with the one or more external devices 106 over a communication network 107 for sending or receiving various data. The external devices 106 may include, but may not be limited to, a remote server, a plurality of sensors, a digital device, or another computing system. It may be noted that the external devices 106 may be fixed on the proximal vehicles and the proximal infrastructures and communicatively coupled with the AGV 105 via the communication network 107.

Referring now to FIG. 2, a functional block diagram of an enhanced FoV generation device 200 (analogous to the enhanced FoV generation device 101 implemented by the system 100 of FIG. 1) is illustrated, in accordance with some embodiments of the present disclosure. The enhanced FoV generation device 200 may include a navigation initiation module (NIM) 201, a path planning module (PPM) 202, a scene segmentation module (SSM) 203, visual data 204, a perception data composition module (PDCM) 205, a trajectory planning and velocity determination module (TP&VDM) 206, and a vehicle localization module (VLM) 207.

In some embodiments, the NIM 201 may be a UI. The NIM 201 may be configured to initiate navigation process from path planning to velocity generation to autonomously drive from a current location of the AGV 105 to a destination. It may be noted that the current location of the AGV 105 may be obtained through a Global Positioning System (GPS) and the destination may be provided by the user through the UI. The UI may include a map displayed to the user. The user may observe the current location of the AGV 105 as a point on the map. In some embodiments, the UI may be touch-enabled. The user may provide the destination by touching on a map location on a drivable road area. Further, the NIM 201 may send the current location of the AGV 105 and the destination to the PPM 202.

The PPM 202 may generate a global path for navigation of the AGV 105 from the current location to the destination using a shortest path algorithm or any other path planning algorithm on a 2D occupancy grid map. It may be noted that for locomotion, the AGV 105 may determine a local path. As will be appreciated, the local path is a part of the global path (for example, 10 to 15 meters of distance) beginning from the current location of the AGV 105. Further, a local path plan may be generated for the local path, based on an on-road visual data. By way of an example, the local path plan may include a local trajectory and a current velocity of the AGV 105. The local path plan may be sent to the TP&VDM 206, to generate an actual velocity.

The SSM 203 may fetch information about each of the set of regions of interest required by the AGV 105. The visual data 204 received from two or more vision sensors corresponding to each of one or more sensor clusters may be processed to determine a perception. It may be noted that the visual data 204 may include camera feed and Light Detection and Ranging (LIDAR) data points. It may also be noted that the two or more vision sensors may be located on at least one of proximal vehicles and proximal infrastructures. Each of the at least one of proximal vehicles may be communicatively connected to the AGV 105 over a Vehicle to Vehicle (V2V) communication network. Each of the at least one of proximal infrastructures may be communicatively connected to the AGV 105 over a Vehicle to Infrastructure (V2I) communication network. Further, the camera feed of each of the two or more vision sensors may be mapped with the corresponding LIDAR data points. Further, the SSM 203 may determine the set of regions of interest in each data of the visual data 204. In some embodiments, parameters for each of the set of regions of interest may be determined for classification. By way of an example, the parameters may include type segregation, coverage, etc. The SSM 203 may send the set of regions of interest in each data of the visual data 204 to the PDCM 205.

The PDCM 205 may integrate the visual data 204 based on volume and varieties to obtain an enhanced perception. For each of the set of regions of interest, the visual data 204 may be received based on context (determined from the camera feed) and volume (determined from the LIDAR data points). Further, the AGV 105 may determine a combined perception from each of the set of regions of interest.

The TP&VDM 206 may generate a current velocity based on a previous velocity and a projected velocity as per the local trajectory, based on the local path plan received from the PPM 202. During planning of the local trajectory, based on the current velocity and a next local path plan (determined by curvature data calculation), determination of the local trajectory may be improved. In some embodiments, the current velocity may be generated over a predefined time interval (for example, 100 ms) and applied to a wheel base of the AGV 105. The projected velocity may be used for further calculations.

The VLM 207 may receive the visual data 204 from the two or more vision sensors corresponding to each of the one or more sensor clusters. In some embodiments, the VLM 207 may collect feedback data from the wheel base of the AGV 105, environmental map data, and LIDAR data points from the two or more vision sensors. Further, the VLM 207 may be configured to continuously determine the current location of the AGV 105 on the map with respect to environment based on the visual data 204. It may be noted that a future local path plan may be determined based on the current location of the AGV 105 considering a first stage trajectory plan strategy and a second stage trajectory plan strategy. The VLM 207 may send the current location of the AGV 105 to the PPM 202 to determine the future local path plan.

It should be noted that all such aforementioned modules 201-207 may be represented as a single module or a combination of different modules. Further, as will be appreciated by those skilled in the art, each of the modules 201-207 may reside, in whole or in parts, on one device or multiple devices in communication with each other. In some embodiments, each of the modules 201-207 may be implemented as dedicated hardware circuit comprising custom application-specific integrated circuit (ASIC) or gate arrays, off-the-shelf semiconductors such as logic chips, transistors, or other discrete components. Each of the modules 201-207 may also be implemented in a programmable hardware device such as a field programmable gate array (FPGA), programmable array logic, programmable logic device, and so forth. Alternatively, each of the modules 201-207 may be implemented in software for execution by various types of processors (e.g., processor 102). An identified module of executable code may, for instance, include one or more physical or logical blocks of computer instructions, which may, for instance, be organized as an object, procedure, function, or other construct. Nevertheless, the executables of an identified module or component need not be physically located together but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for generating an enhanced FoV for the AGV 105. For example, the exemplary system 100 and the associated enhanced FoV generation device 101 may generate the enhanced FoV for the AGV 105 by the processes discussed herein. In particular, as will be appreciated by those of ordinary skill in the art, control logic and/or automated routines for performing the techniques and steps described herein may be implemented by the system 100 and the associated enhanced FoV generation device 101 either by hardware, software, or combinations of hardware and software. For example, suitable code may be accessed and executed by the one or more processors on the system 100 and the associated enhanced FoV generation device 101 to perform some or all of the techniques described herein. Similarly, application specific integrated circuits (ASICs) configured to perform some or all of the processes described herein may be included in the one or more processors on the system 100 or the associated enhanced FoV generation device 101.

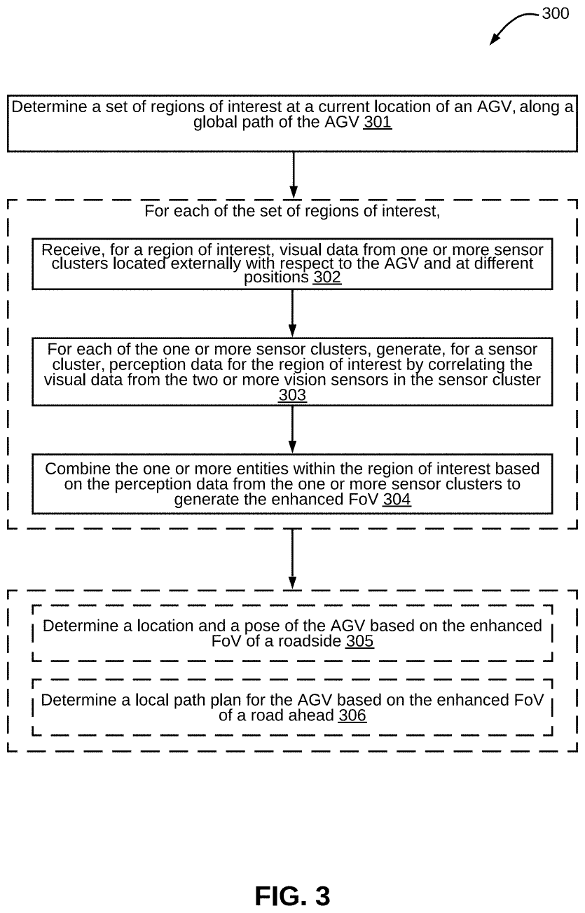

Referring now to FIG. 3, an exemplary method 300 of generating the enhanced FoV for the AGV 105 is illustrated via a flow chart, in accordance with some embodiments of the present disclosure. The method 300 may be implemented by the enhanced FoV generation device 101. The current location of the AGV 105 may be obtained through the GPS and the destination location may be provided by the user through the UI. In an embodiment, the VLM 207 may provide the current location of the AGV 105. The global path of the AGV 105 may be determined by the PPM 202 based on the current location and the destination location. Further, a local trajectory and a current velocity may be generated for the AGV 105 along the global path of the AGV 105 by the PPM 202 in conjunction with the TP&VDM 206 of the enhanced FoV generation device 200.

The method 300 may further include determining a set of regions of interest at a current location of an AGV, along a global path of the AGV, at step 301. For each of the set of regions of interest, at step 302, the method 300 may further include receiving, for a region of interest, the visual data 204 from one or more sensor clusters located externally with respect to the AGV 105 and at different positions. It may be noted that each of the one or more sensor clusters comprises two or more vision sensors at co-located frame position. In some embodiments, the visual data 204 may include at least one of on-road visual data and road-side visual data. Additionally, in some embodiments, the visual data 204 from the two or more vision sensors may include at least one of camera feed and LIDAR data points. Further, in some embodiments, the one or more sensor clusters may be located on at least one of a proximal vehicle and a proximal infrastructure. It should be noted that the proximal vehicle may be communicatively connected to the AGV 105 over a Vehicle to Vehicle (V2V) communication network. Further, it should be noted that the proximal infrastructure may be communicatively connected to the AGV 105 over a Vehicle to Infrastructure (V2I) communication network. In some embodiments, the steps 301-302 may be performed by the SSM 203.

Further, for each of the set of regions of interest, the method may include for each of the one or more sensor clusters, generating, for a sensor cluster, perception data for the region of interest by correlating the visual data from the two or more vision sensors in the sensor cluster, at step 303. The perception data may corresponds to one or more entities (for example, a pedestrian, a biker, free road, etc.) within the region of interest. In an embodiment, the perception data may be a contour region corresponding to each of the one or more entities. By way of an example, correlating the visual data 204 from the two or more vision sensors may include correlating the camera feed and the LIDAR data points. It may be noted that the correlation may be performed in a variety of ways. For example, in some embodiments, for each of the two vision sensors from the two or more vision sensors, a first visual data may be identified from a first vision sensor. A semantic segmented visual scene may be then determined based on second visual data from a second source. Further, the first visual data may be filtered based on the semantic segmented visual scene to generate correlated visual data. Further, for example, in some embodiments, a common reference point may be selected for each of the one or more entities for each of the one or more sensor clusters. The one or more entities may be combined within the region of interest based on the common reference point. The common reference point may be a current location of the AGV 105. In some embodiments, a semantic visual scene may be extracted from first visual data received from a first set of the plurality of sensors. The corresponding visual data (i.e., the correlated visual data) may be extracted, from the visual data received from one or more of a remaining set of the plurality of sensors, based on the semantic visual scene. In some embodiments, the step 303 may be performed by the PDCM 204.

Further, for each of the set of regions of interest, first visual data may be identified from a first vision sensor for each of the two vision sensors from the two or more vision sensors. In some embodiments, for each of the two vision sensors from the two or more vision sensors, a semantic segmented visual scene may be determined based on second visual data from a second vision sensor. Further, in some embodiments, for each of the two vision sensors from the two or more vision sensors, the first visual data may be filtered based on the semantic segmented visual scene.

In some embodiments, the method 300 may include determining a location and a pose of the AGV 105 based on the enhanced FoV of a roadside, at step 305. Additionally, in some embodiments, the method 300 may include determining a local path plan for the AGV 105 based on the enhanced FoV of a road ahead, at step 306. In some embodiments, the step 306 may be performed by the VLM 207 and TP&VDM 206, respectively.

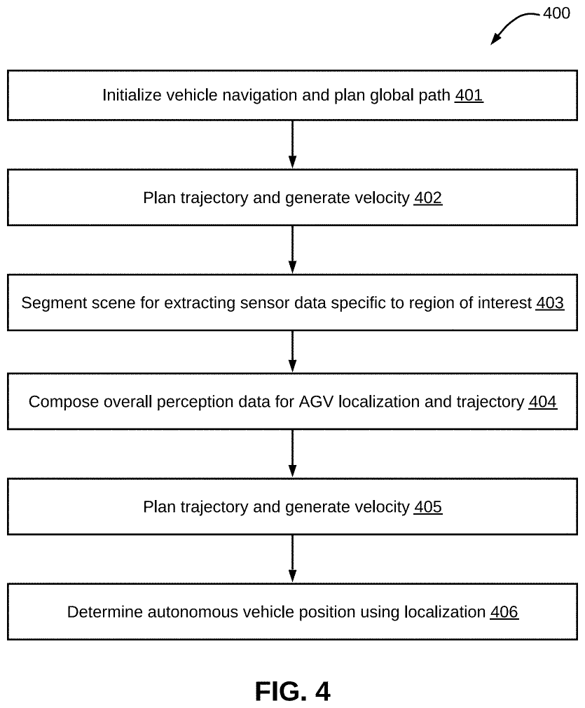

Referring now to FIG. 4, a detailed exemplary method 400 of generating the enhanced FoV for the AGV 105 is illustrated via a flowchart, in accordance with some embodiments of the present disclosure. The method 400 may be employed by the enhanced FoV generation device 101. The method 400 may include initializing vehicle navigation and planning global path, at step 401. In some embodiments, the step 401 may be implemented by the NIM 201 and the PPM 202. The map may be displayed to the user through the UI. The user may view the current location of the AGV 105 in form of a point on the map. The map may be touch enabled for the user to choose the destination on the map (on a drivable road region) by means of a touch. Further, the PPM 202 may be initiated to produce the global path for the navigation of the AGV 105 from the current location to the destination using a shortest path algorithm or any other path planning algorithm on a 2D occupancy grid map and a global path plan may be generated.

Further, the method 400 may include planning trajectory and velocity generation, at step 402. The step 402 may be implemented by the TP&VDM 206. It may be noted that for locomotion, the AGV 105 may determine the local path beginning from the current location of the AGV 105. Further, the local path plan may be generated for the local path, based on the on-road visual data. By way of an example, the local path plan may include a local trajectory and a current velocity of the AGV 105. The local path plan may be used for current velocity generation. The TP&VDM 206 may generate the current velocity based on the previous velocity and the projected velocity of the AGV 105 determined from the local path plan. During planning of the local trajectory, based on the current velocity and a next local path plan (determined by curvature data calculation), determination of the local trajectory may be improved. In some embodiments, the current velocity may be generated over a predefined time interval (for example, 100 ms) and applied to a wheel base of the AGV 105. The projected velocity may be used for further calculations.

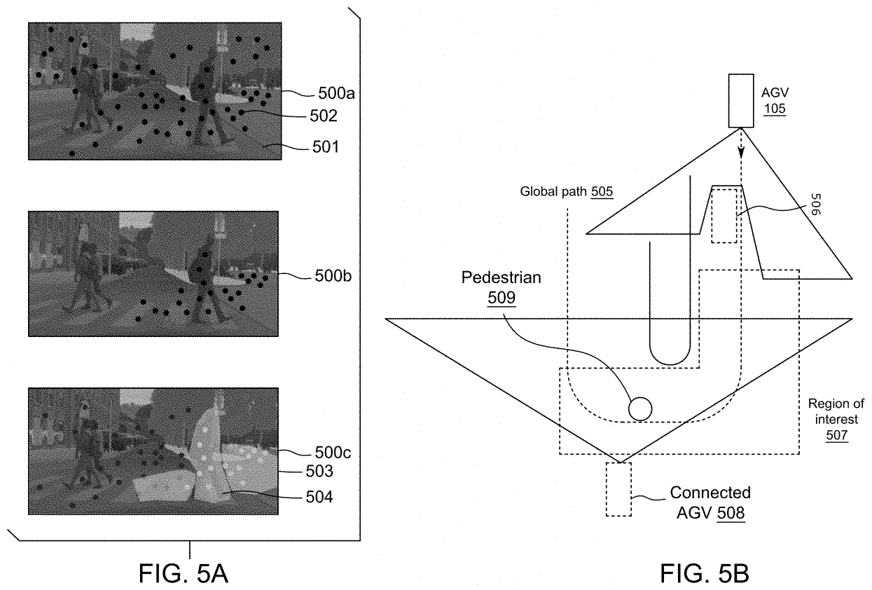

Further, the method 400 may include segmenting scenes for extracting sensor data specific to region of interest, at step 403. The SSM 203 may be configured to request on-road visual data from the proximal vehicles or road-side visual data from the proximal infrastructures. Further, the SSM 203 may divide the visual data 204 corresponding to an area surrounding the AGV 105 into the set of regions of interest. For each of a plurality of areas, the visual data 204 may be requested separately by the AGV 105. The visual data 204 may be collected through state of the art V2V and V2I technologies. The location and the pose of the AGV 105 may be determined based on the road-side visual data. The local path plan for the AGV 105 may be determined based on the on-road visual data. This is further explained in conjunction with FIGS. 5A-B and 6A-B.

Referring now to FIGS. 5A and 5B, identification of one or more entities corresponding to each of the set of regions of interest in on-road visual data is illustrated, in accordance with some embodiments of the present disclosure. In FIG. 5A, the enhanced FoV generation device 101 may process the on-road visual data in three stages 500a, 500b, and 500c. At stage 500a, the enhanced FoV generation device 101 may receive the on-road visual data as the camera feed 501 and the LIDAR data points 502 from two or more vision sensors corresponding to each of the one or more sensor clusters. The camera feed and the LIDAR data points may be combined for further data processing. At stage 500b, the enhanced FoV generation device 101 may determine a set of regions of interest within the on-road visual data. The LIDAR data points for each of the set of regions of interest may be mapped with the camera feed one at a time to process relevant on-road visual data. At stage 500c, at least one contour may be generated for a region of interest by correlating the on-road visual data from the two or more vision sensors. Further, at stage 500c, the enhanced FoV generation device 101 may identify one or more entities corresponding to each of the at least one contour within the region of interest. It may be noted that the at least one contour may be analogous to the perception data. By way of an example, the one or more entities may be a free road 503, a pedestrian 504, and the like.

In FIG. 5B, the global path 505 of the AGV 105 may be determined by the PPM 202. Further, the set of regions of interest may be determined for the global path 505. A blocking vehicle 506 may be moving along the global path 505 in front of the AGV 105. It may be noted that the blocking vehicle is not communicatively connected with the AGV 105. Further, the blocking vehicle 506 may be blocking the plurality of sensors of the AGV 105 from capturing on-road visual data of a region of interest 507 along the global path 505. It may be noted that the region of interest 507 may belong to the set of regions of interest. In such scenarios, the on-road visual data may be received by the AGV 105 from the connected AGV 508, which is communicatively connected to the AGV 105 through the V2V communication network. The on-road visual data received from the connected AGV 508 may allow the AGV 105 to generate a local path plan by detecting a pedestrian 509 which might not have been detected due to a presence of the blocking vehicle 506.

It may be noted that the region of interest 507 may be of any shape. Each of the set of regions of interest may be defined by an array of coordinate points. By way of an example, the region of interest 507 may be represented as follows:

```
Struct region A {
    float PointOne[2];
    float PointTwo[2];
    .....
    float PointTwo[n];
}
```

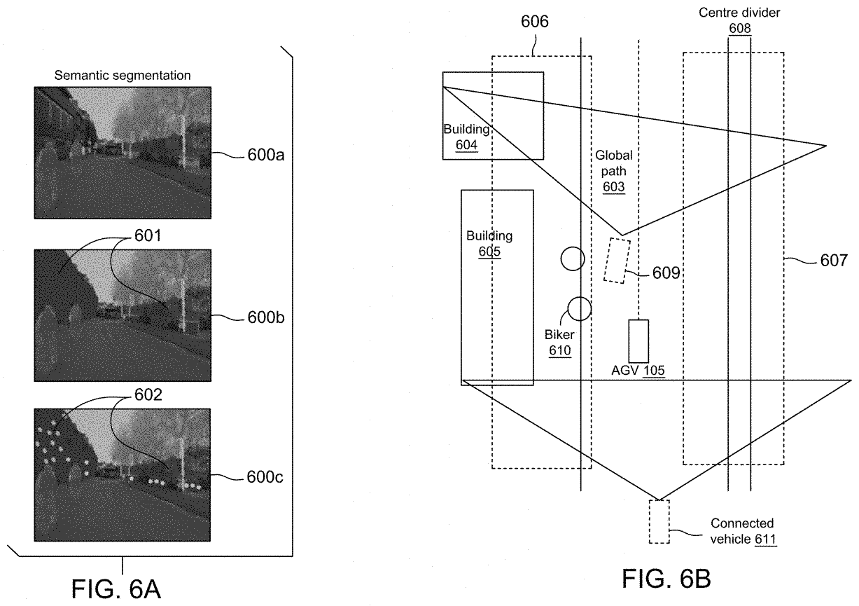

Referring now to FIGS. 6A and 6B, identification of one or more entities corresponding to each of the set of regions of interest in road-side visual data is illustrated, in accordance with some embodiments of the present disclosure. In FIG. 6A, the enhanced FoV generation device 101 may process the road-side visual data in three stages 600a, 600b, and 600c. At stage 600a, the enhanced FoV generation device 101 may receive the road-side visual data as the camera feed from two or more vision sensors corresponding to each of one or more sensor clusters. At stage 600b, the enhanced FoV generation device 101 may determine a set of regions of interest 601 within the road-side visual data. At stage 600c, the LIDAR data points 602 for each of the set of regions of interest 601 may be mapped with the camera feed one at a time to process relevant road-side visual data. Further, the enhanced FoV generation device 101 may identify an infrastructure corresponding to each of the LIDAR points 602 within the each of the set of regions of interest 601. By way of an example, the infrastructure may be a building, a divider, and the like.

In FIG. 6B, the global path 603 of the AGV 105 may be determined by the PPM 202. The AGV 105 may receive the road-side visual data from a plurality of sensors located on a building 604 and a building 605, which is communicatively connected to the AGV 105 through the V2I communication network. The buildings 604 and 605 may be located towards left of the AGV 105. A region of interest 606 may be covered through the plurality of sensors of the buildings 604 and 605. Further, on other side of the AGV 105, a region of interest 607 may be covered through the plurality of sensors located on a central divider 608. A blocking vehicle 609 may be moving in front of the AGV 105 along the global path 603. It may be noted that the blocking vehicle 609 may be blocking the visual sensors of the AGV 105 from identifying the proximal infrastructures (for example, the buildings 604 and 605). Further, a biker 610 may be identified through at least one of the buildings 604 and 605 and a connected vehicle 611. It may be noted that the connected vehicle 611 may be communicatively connected with the AGV 105 through the V2V communication network. Further, the road-side visual data may be used to determine the location and the pose of the AGV 105.

Referring back to FIG. 4, the method 400 may include composing overall perception data for localization of the AGV 105 and trajectory planning, at step 404. Contribution and effectiveness of each of the two or more vision sensors corresponding to each of the one or more sensor clusters in building perception may be identified. When the visual data 204 (with combined camera feed and LIDAR data points) from each of the two or more vision sensors may be received, the visual data 204 may be analyzed for significance. The significance of each data of the visual data 204 may be labelled with a weightage value. The AGV 105 may determine an acceptance or rejection of the visual data 204 from each of the two or more vision sensors based on a combined perception received from each of the set of regions of interest. A region volume may be calculated for each of a region of interest through the following equation:

Vᵣ=Aᵣ*H (1)

wherein,
‘Aᵣ’ is an area of the region of interest; and
‘H’ is a predefined height (for example, 10 meters)

Further, a weight (Wᵣ) of the region of interest may be determined through the following equation:

$${W}_{r} = \frac{Number of relevant LIDAR data points}{{V}_{r} * 1000} + type of information \qquad ( 2 )$$

wherein,
‘type of information’ is one of categories based on the region of interest (for example, road side infrastructure, pedestrian, bicycle, vehicles, free road regions, and the like)

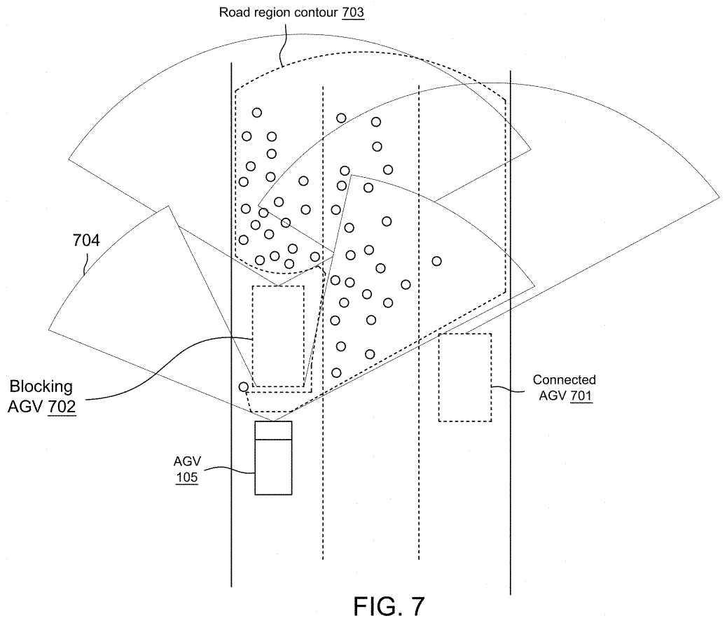

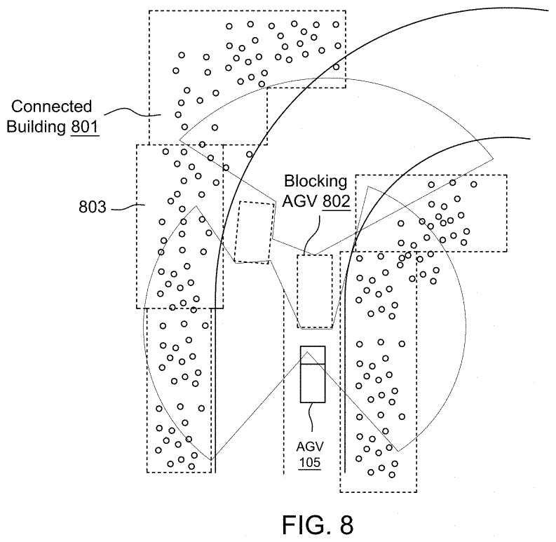

‘Wr’ values may be arranged from high weightage to low weightage. The AGV 105 may receive the visual data 204 for a region of interest, from a set of vision sensors selected from the two or more vision sensors correspond to each of the one or more vision sensors with the ‘Wᵣ’ values above a predefined threshold weight. Coordinate points of each of the set of regions of interest are determined in reference to a common reference point. In some embodiments, the common reference point may be a center point of the AGV 105 on a central map. Further, the visual data 204 from each of the plurality of sensors external to the AGV 105 may be in reference to the central map. Further, the visual data 204 corresponding to the region of interest on the map may be extracted and combined with the visual data 204 from each of the plurality of sensors from a different source in the region of interest. This is further explained in conjunction with FIG. 7 and FIG. 8.

Referring now to FIG. 7, generation of a local path by combining the on-road visual data received from the two or more vision sensors is illustrated, in accordance with some embodiments of the present disclosure. The AGV 105 may be communicatively connected with a connected AGV 701 through the V2V communication network. In an exemplary scenario, a blocking AGV 702 may be moving in front of the AGV 105. In such a scenario, a road region contour 703 may be obtained by combining the visual data 204 received from the plurality of sensors located on the AGV 105 and the connected AGV 701. The road region contour 703 may provide an enhanced FoV to the AGV 105. Without the visual data 204 from the connected AGV 105, the FoV 704 of the AGV 105 may be reduced due to the blocking AGV 702. However, by combining the on-road visual data of the AGV 105 and the on-road visual data received from the connected AGV 701, the road region contour 703 may be generated. Further, the road region contour 703 may be used to determine the local path plan for the AGV 105.

Referring now to FIG. 8, localization of the AGV 105 by combining the road-side visual data received from the two or more vision sensors is illustrated, in accordance with some embodiments of the present disclosure. The AGV 105 may be communicatively connected with a connected building 801 through the V2I communication network. A blocking vehicle 802 may be moving in front of the AGV 105. In some scenarios, an FoV of the AGV 105 may be reduced due to the blocking vehicle 802. In such scenarios, the plurality of sensors of the AGV 105 may not provide road-side visual data (for example, a region of interest 803) for localization to the enhanced FoV generation device 101. The plurality of sensors located on the connected building 801 may provide the road-side visual data to the enhanced FoV generation device 101. Further, the road-side visual data may be combined to generate localization information (for example, a location, a pose, and the like) for the AGV 105.

Referring back to FIG. 4, the method 400 may further include planning trajectory and generation of velocity, at step 405. In this step, the TP&VDM 206 may generate the current velocity based on the previous velocity and the projected velocity determined from the local path plan. During planning of the local trajectory, based on the current velocity and a next local path plan (determined by curvature data calculation), determination of the local trajectory may be improved. In some embodiments, the current velocity may be generated over a predefined time interval (for example, 100 ms) and applied to a wheel base of the AGV 105. The projected velocity may be used for further calculations.

Further, the method 400 may include determining position of autonomous vehicle using localization, at step 406. The VLM 207 may collect the visual data 204 from the two or more vision sensors corresponding to each of the one or more sensor clusters. In some embodiments, the VLM 207 may collect feedback data from the wheel base of the AGV 105, environmental map data, and LIDAR data points from the two or more vision sensors. Further, the VLM 207 may be configured to continuously determine the current location of the AGV 105 on the map with respect to environment based on the visual data 204. It may be noted that a future local path plan may be determined based on the current location of the AGV 105 considering a first stage trajectory plan strategy and a second stage trajectory plan strategy. Further, the VLM 207 may send the current location of the AGV 105 to the PPM 202 to determine the future local path plan.

As will be also appreciated, the above described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits. The disclosed methods and systems may be implemented on a conventional or a general-purpose computer system, such as a personal computer (PC) or server computer.

Thus, the disclosed method and system succeed in overcoming the technical problem of generating an enhanced FoV for an AGV. The method and system determine a set of regions of interest on a global path of the AGV. Further, the method and system receive visual data from one or more sensor clusters located externally with respect to the AGV. The visual data may include camera feed and LIDAR data points. The one or more sensor clusters may be located on proximal vehicles communicatively connected with the AGV 105 through the V2V communication network, or proximal infrastructures communicatively connected with the AGV 105 through the V2I communication network. Further, perception data may be generated for each of the set of regions of interest by correlating the camera feed and the LIDAR data points from each of the two or more sensors in the sensor cluster. The perception data may correspond to one or more entities (for example, a pedestrian, a biker, a building, and the like). Further, the one or more entities within a region of interest may be identified based on the perception data to generate an enhanced FoV. The method and system determine relevant vision sensors from the two or more vision sensors corresponding to each of the one or more sensor clusters by assigning weightage to the visual data received from each of the two or more vision sensors. Further, the method and system determine an enhanced FoV for the AGV when the FoV of the AGV is blocked by another vehicle. The method and system determine a local path plan based on integration of on-road visual data received from a plurality of sensors. Additionally, the method and system determine a location and a pose of the AGV based on integration of road-side visual data.

Specifically, the claimed limitations of the present disclosure address the technical challenge by determining a set of regions of interest along a global path of an AGV based on an existing FoV of the AGV, and for each of the set of regions of interest, receiving visual data from one or more sensor clusters located externally with respect to the AGV, generating perception data for the region of interest by correlating the visual data from the one or more sensor clusters, and identifying the one or more entities within the region of interest based on the perception data to generate the enhanced FoV.

As will be appreciated by those skilled in the art, the techniques described in the various embodiments discussed above are not routine, or conventional, or well understood in the art. The techniques discussed above provide for generating an enhanced FoV for an AGV. The techniques first determine a set of regions of interest at a current location of an AGV, along a global path of the AGV. The techniques may then receive visual data for a region of interest from one or more sensor clusters located externally with respect to the AGV and at different positions for each of the set of regions of interest. The techniques may then generate, for each of the one or more sensor clusters, perception data for the region of interest by correlating the visual data from the two or more vision sensors in the sensor cluster, for each of the set of regions of interest. The techniques may then combine the one or more entities within the region of interest based on the perception data from the one or more sensor clusters to generate the enhanced FoV, for each of the set of regions of interest.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described method and system for generating an enhanced FoV for an AGV. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of generating an enhanced field of view (FoV) for an Autonomous Ground Vehicle (AGV), the method comprising:
determining, by an enhanced FoV generation device, a set of regions of interest at a current location of an AGV, along a global path of the AGV;
for each of the set of regions of interest,
receiving, for a region of interest by the enhanced FoV generation device, visual data from one or more sensor clusters located externally with respect to the AGV and at different positions, wherein each of the one or more sensor clusters comprises two or more vision sensors at co-located frame position;
for each of the one or more sensor clusters, generating, for a sensor cluster by the enhanced FoV generation device, perception data for the region of interest by correlating the visual data from the two or more vision sensors in the sensor cluster, wherein the perception data corresponds to one or more entities within the region of interest; and
combining, by the enhanced FoV generation device, the one or more entities within the region of interest based on the perception data from the one or more sensor clusters to generate the enhanced FoV.

2. The method of claim 1, wherein the visual data comprises at least one of on-road visual data and road-side visual data, wherein the visual data from the two or more vision sensors in the sensor cluster comprises at least one of camera feed and Light Detection and Ranging (LIDAR) data points.

3. The method of claim 1, wherein each of the one or more sensor clusters are located on at least one of a proximal vehicle and a proximal infrastructure, wherein the proximal vehicle is communicatively connected to the AGV over a Vehicle to Vehicle (V2V) communication network, and wherein the proximal infrastructure is communicatively connected to the AGV over a Vehicle to Infrastructure (V2I) communication network.

4. The method of claim 1, wherein correlating the visual data from the two or more vision sensors in the sensor cluster further comprises:
for each of the two vision sensors from the two or more vision sensors, identifying first visual data from a first vision sensor;
determining a semantic segmented visual scene based on second visual data from a second vision sensor; and
filtering the first visual data based on the semantic segmented visual scene.

5. The method of claim 4, wherein the two or more vision sensors comprises a LIDAR sensor and a camera sensor, wherein the first visual data is LIDAR data points from the LIDAR sensor, and wherein the second visual data is camera feed from the camera sensor.

6. The method of claim 1, wherein combining the one or more entities within the region of interest further comprises:
selecting a common reference point for each of the one or more entities for each of the one or more sensor clusters, wherein the common reference point is a current location of the AGV; and
combining the one or more entities within the region of interest based on the common reference point.

7. The method of claim 1, further comprising at least one of:
determining a location and a pose of the AGV based on the enhanced FoV of a roadside; and
determining a local path plan for the AGV based on the enhanced FoV of a road ahead.

8. A system for generating an enhanced field of view (FoV) for an Autonomous Ground Vehicle (AGV), the system comprising:
a processor; and
a computer-readable medium communicatively coupled to the processor, wherein the computer-readable medium stores processor-executable instructions, which when executed by the processor, cause the processor to:
determine a set of regions of interest at a current location of an AGV, along a global path of the AGV;
for each of the set of regions of interest,
receive, for a region of interest, visual data from one or more sensor clusters located externally with respect to the AGV and at different positions, wherein each of the one or more sensor clusters comprises two or more vision sensors at co-located frame position;
for each of the one or more sensor clusters, generate, for a sensor cluster, perception data for the region of interest by correlating the visual data from the two or more vision sensors in the sensor cluster, wherein the perception data corresponds to one or more entities within the region of interest; and
combine the one or more entities within the region of interest based on the perception data from the one or more sensor clusters to generate the enhanced FoV.

9. The system of claim 8, wherein the visual data comprises at least one of on-road visual data and road-side visual data, wherein the visual data from the two or more vision sensors in the sensor cluster comprises at least one of camera feed and Light Detection and Ranging (LIDAR) data points.

10. The system of claim 8, wherein each of the one or more sensor clusters are located on at least one of a proximal vehicle and a proximal infrastructure, wherein the proximal vehicle is communicatively connected to the AGV over a Vehicle to Vehicle (V2V) communication network, and wherein the proximal infrastructure is communicatively connected to the AGV over a Vehicle to Infrastructure (V2I) communication network.

11. The system of claim 8, wherein to correlate the visual data from the two or more vision sensors in the sensor cluster, the processor-executable instructions, on execution, further cause the processor to:
for each of the two vision sensors from the two or more vision sensors, identify first visual data from a first vision sensor;
determine a semantic segmented visual scene based on second visual data from a second vision sensor; and
filter the first visual data based on the semantic segmented visual scene.

12. The system of claim 11, wherein the two or more vision sensors comprises a LIDAR sensor and a camera sensor, wherein the first visual data is LIDAR data points from the LIDAR sensor, and wherein the second visual data is camera feed from the camera sensor.

13. The system of claim 8, wherein to combine the one or more entities within the region of interest, the processor-executable instructions, on execution, further cause the processor to:
select a common reference point for each of the one or more entities for each of the one or more sensor clusters, wherein the common reference point is a current location of the AGV; and
combine the one or more entities within the region of interest based on the common reference point.

14. The system of claim 8, wherein the processor-executable instructions, on execution, further cause the processor to, at least one of:
determine a location and a pose of the AGV based on the enhanced FoV of a roadside; and
determine a local path plan for the AGV based on the enhanced FoV of a road ahead.

15. A non-transitory computer-readable medium storing computer-executable instructions for generating an enhanced field of view (FoV) for an Autonomous Ground Vehicle (AGV), the computer-executable instructions are executed for:
determining a set of regions of interest at a current location of an AGV, along a global path of the AGV;
for each of the set of regions of interest,
receiving, for a region of interest, visual data from one or more sensor clusters located externally with respect to the AGV and at different positions, wherein each of the one or more sensor clusters comprises two or more vision sensors at co-located frame position;
for each of the one or more sensor clusters, generating, for a sensor cluster, perception data for the region of interest by correlating the visual data from the two or more vision sensors in the sensor cluster, wherein the perception data corresponds to one or more entities within the region of interest; and
combining the one or more entities within the region of interest based on the perception data from the one or more sensor clusters to generate the enhanced FoV.

16. The non-transitory computer-readable medium of claim 15, wherein the visual data comprises at least one of on-road visual data and road-side visual data, wherein the visual data from the two or more vision sensors in the sensor cluster comprises at least one of camera feed and Light Detection and Ranging (LIDAR) data points.

17. The non-transitory computer-readable medium of claim 15, wherein each of the one or more sensor clusters are located on at least one of a proximal vehicle and a proximal infrastructure, wherein the proximal vehicle is communicatively connected to the AGV over a Vehicle to Vehicle (V2V) communication network, and wherein the proximal infrastructure is communicatively connected to the AGV over a Vehicle to Infrastructure (V2I) communication network.

18. The non-transitory computer-readable medium of claim 15, wherein for correlating the visual data from the two or more vision sensors in the sensor cluster, the computer-executable instructions are further executed for:
for each of the two vision sensors from the two or more vision sensors, identifying first visual data from a first vision sensor;
determining a semantic segmented visual scene based on second visual data from a second vision sensor; and
filtering the first visual data based on the semantic segmented visual scene.

19. The non-transitory computer-readable medium of claim 15, wherein for combining the one or more entities within the region of interest, the computer-executable instructions are further executed for:
selecting a common reference point for each of the one or more entities for each of the one or more sensor clusters, wherein the common reference point is a current location of the AGV; and
combining the one or more entities within the region of interest based on the common reference point.

20. The non-transitory computer-readable medium of claim 15, further storing computer-executable instructions for:
determining a location and a pose of the AGV based on the enhanced FoV of a roadside; and
determining a local path plan for the AGV based on the enhanced FoV of a road ahead.
